(19) United States
(12) Patent Application Publication
(10) Pub. No.: US 2026/0249531 A1
(43) Pub. Date: Aug. 27, 2026

(54) VACUUM DEGASSER, INJECTION UNIT PROVIDED WITH SAME, AND METHOD FOR VACUUM DEGASSING

(71) Applicant: THE JAPAN STEEL WORKS, LTD., Tokyo (JP)

(72) Inventors: Yuki KAJIWARA, Tokyo (JP); Hideki CHIBA, Tokyo (JP); Tetsuya YAMAMOTO, Hiroshima (JP)

(21) Appl. No.: 19/536,874

(22) Filed: Feb. 11, 2026

(30) Foreign Application Priority Data
Feb. 27, 2025 (JP) 2025-030098

(51) Int. Cl. B29C 45/14; B29C 45/50; B29C 45/52; B29C 45/77

(52) U.S. Cl. CPC B29C 45/14655; B29C 45/5008; B29C 45/52; B29C 45/77

(57) ABSTRACT

A vacuum degasser comprises conveyance equipment that conveys a molding material into an injection cylinder, a material supply path that is provided between the injection cylinder and the conveyance equipment and that supplies the molding material to the injection cylinder, a cutoff device that divides the material supply path into an upstream section that is connected to the conveyance equipment and a downstream section that is connected to the injection cylinder, a vacuum pump that is connected to the downstream section, and an atmospheric relief valve that is connected to the downstream section. The atmospheric relief valve is opened in a state that precedes a measurement process and that the cutoff device and the atmospheric relief valve are closed and the vacuum pump is in operation.

### FIELD

This application claims the benefit of Japanese Priority Patent Application No. 2025-030098 filed on February 27, 2025, the entire contents of which are incorporated herein by reference.

The present invention relates to a vacuum degasser, an injection unit provided with same, and a method for vacuum degassing.

### BACKGROUND

Water and volatile components contained in a molding material cause various defects such as bubbles in molded products. Japanese Patent Application Laid-Open No. 2011-83953 describes a vacuum degasser that removes water and volatile components from a molding material by creating a vacuum around the molding material. The vacuum degasser comprises a cutoff device that maintains an injection cylinder in a vacuum state and a vacuum pump that draws gases from inside the injection cylinder.

### SUMMARY

The vacuum degasser described in Japanese Patent Application Laid-Open No. 2011-83953 removes water and volatile components from the molding material only by the suction force of the vacuum pump and therefore is inefficient in removing water and volatile components.

The object of the present disclosure is to provide a vacuum degasser that can more efficiently remove water and volatile components contained in a molding material.

The vacuum degasser of the present disclosure comprises a cutoff device that divides a material supply path into an upstream section that is connected to conveyance equipment and a downstream section that is connected to an injection cylinder, a vacuum pump that is connected to the downstream section, and an atmospheric relief valve that is connected to the downstream section. The atmospheric relief valve is opened in a state that precedes a measurement process and that the vacuum pump is in operation and the cutoff device and the atmospheric relief valve are closed.

The objects, features, and advantages of the present application, above and otherwise, will become apparent from the detailed description set forth below with reference to the accompanying drawings that illustrate the present application.

### BRIEF DESCRIPTION OF THE DRAWINGS

FIG. 1 is a schematic front view of an injection molding machine according to an embodiment of the present disclosure;

FIG. 2 is a schematic configuration diagram of the vacuum degasser of the injection molding machine shown in FIG. 1;

FIG. 3A is a diagram showing the operation of the vacuum degasser shown in FIG. 2;

FIG. 3B is a diagram showing the operation of the vacuum degasser shown in FIG. 2;

FIG. 3C is a diagram showing the operation of the vacuum degasser shown in FIG. 2;

FIG. 3D is a diagram showing the operation of the vacuum degasser shown in FIG. 2;

FIG. 3E is a diagram showing the operation of the vacuum degasser shown in FIG. 2;

FIG. 4A is a diagram showing the operation of a vacuum degasser in a comparative example;

FIG. 4B is a diagram showing the operation of the vacuum degasser in the comparative example;

FIG. 4C is a diagram showing the operation of the vacuum degasser in the comparative example; and

FIG. 4D is a diagram showing the operation of the vacuum degasser in the comparative example.

### DETAILED DESCRIPTION

An embodiment of the present disclosure is next described with reference to the drawings. The embodiment described below relates to a horizontal injection unit for injecting resin and a horizontal injection molding machine provided with the unit, but the present disclosure can also be applied to a vertical injection unit and a metal injection unit. In the following description and drawings, the axial direction of the injection cylinder and injection screw is referred to as the X-direction. The X-direction is parallel to the horizontal direction. The direction from the injection unit toward a mold-clamping unit or in the injection direction is referred to as the +X-direction, and the direction from the mold-clamping unit toward the injection unit is referred to as the −X-direction. The vertical direction is referred to as the Z-direction.

### Overall C onfiguration

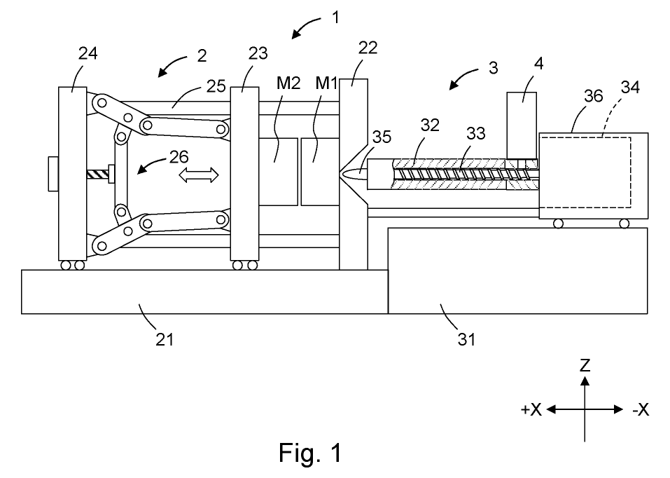

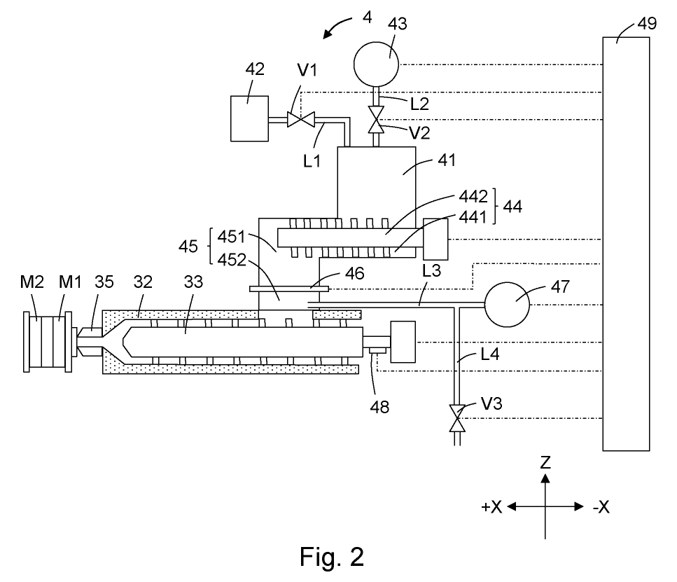

FIG. 1 shows a schematic front view of injection molding machine 1 according to an embodiment of the present disclosure. FIG. 2 shows a schematic front view of injection unit 3 of injection molding machine 1 shown in FIG. 1. Injection molding machine 1 generally comprises mold-clamping unit 2 that secures the mold and that opens and closes the mold, and injection unit 3 that heats and melts a material to be injected (molding material) and that injects the material.

As shown in FIG. 1, mold-clamping unit 2 comprises fixed platen 22 that is fixed on bed 21 and to which fixed mold M1 is attached, mold-clamping housing 24 that can slide on bed 21, and movable platen 23 that can slide on bed 21 and to which movable mold M2 is attached. Fixed platen 22 and mold-clamping housing 24 are connected by a plurality of tie bars 25. Mold-clamping mechanism 26 is provided between movable platen 23 and mold-clamping housing 24 to open and close the mold. Mold-clamping mechanism 26 is configured as a toggle mechanism but may also be configured as a hydraulic mold-clamping injection cylinder.

Injection unit 3 is provided on base 31. Injection unit 3 comprises injection cylinder 32, injection screw 33 that is housed in injection cylinder 32 and that kneads and plasticizes a molding material (e.g., resin pellets), and drive mechanism 34 that drives injection screw 33 in the X-direction and that rotates injection screw 33 around its central axis. Injection cylinder 32 is a generally cylindrical member that houses injection screw 33 and that has an internal space through which the molding material flows. Injection nozzle 35 for injecting molding material is provided at the tip of injection cylinder 32 in the +X-direction. Drive mechanism 34 is covered by cover 36.

### Vacuum D egasser 4

FIG. 2 shows a schematic configuration of vacuum degasser 4. Injection unit 3 comprises vacuum degasser 4 that is attached to injection cylinder 32. Vacuum degasser 4 removes water and volatile components from the molding material that is to be supplied to injection cylinder 32 and supplies the molding material from which water and volatile components have been removed to injection cylinder 32. Vacuum degasser 4 comprises hopper 41, material tank 42, evacuation blower 43, conveyance equipment 44, material supply path 45, cutoff device 46, vacuum pump 47, detection device 48, control unit 49, and atmospheric relief valve V3. Control unit 49 controls the operation of evacuation blower 43, conveyance equipment 44, cutoff device 46, vacuum pump 47, and atmospheric relief valve V3. Although configured as part of vacuum degasser 4 in the present embodiment, control unit 49 can also be part of a control panel (not shown) of injection unit 3.

Hopper 41 and material tank 42 are containers for temporarily storing the molding material to be supplied to injection cylinder 32 and can be formed of steel plates or other materials. Material tank 42 is provided with a feed port (not shown) into which molding material is fed from the outside. Hopper 41 and material tank 42 are connected via material feed pipe L1. Material feed pipe L1 is provided with feed control valve V1. Evacuation blower 43 is connected to hopper 41 via blower suction pipe L2. Blower suction pipe L2 is provided with suction control valve V2.

Closing feed control valve V1 shuts off the connection between hopper 41 and material tank 42 and closing suction control valve V2 shuts off the connection between hopper 41 and evacuation blower 43. Feed control valve V1 and suction control valve V2 are closed except when molding material is transferred from material tank 42 to hopper 41. Feed control valve V1 and suction control valve V2 are closed while cutoff device 46 is open. Feed control valve V1, suction control valve V2, and evacuation blower 43 are connected to control unit 49.

The timing for feeding molding material to hopper 41 is not limited as long as cutoff device 46 is closed and feeding may be effected at any time between the end of the measurement process of the previous cycle and the start of the measurement process of the next cycle. In addition, molding material equivalent to multiple injections can be supplied to hopper 41 all at once, and feed control valve V1 and suction control valve V2 can therefore be opened and closed only once per multiple injection cycles. The measurement process is the process of heating and melting (plasticizing) the molding material and conveying the melted molding material to the front (the +X-direction side) of injection screw 33, and these processes are executed simultaneously.

Conveyance equipment 44 comprises feed cylinder 441 and feed screw 442. Conveyance equipment 44 conveys the molding material to injection cylinder 32. Feed screw 442 is housed in feed cylinder 441. Feed cylinder 441 is positioned directly below hopper 41 and is connected to both hopper 41 and material supply path 45. As feed screw 442 rotates, the molding material remaining on feed screw 442 is conveyed, whereby the molding material falls down through material supply path 45 and is fed to injection cylinder 32.

Material supply path 45 is provided between conveyance equipment 44 and injection cylinder 32. Material supply path 45 functions as a guideway to supply molding material conveyed by feed screw 442 to injection cylinder 32. Material supply path 45 can be divided by cutoff device 46 into upstream section 451 that is connected to conveyance equipment 44 and downstream section 452 that is connected to injection cylinder 32. Upstream section 451 is positioned above downstream section 452 in the Z-direction. When cutoff device 46 is closed, upstream section 451 forms an integral space with feed cylinder 441 and hopper 41, while downstream section 452 forms an integral space with injection cylinder 32. Cutoff device 46 can be formed, for example, by a valve. Cutoff device 46 is connected to control unit 49.

Vacuum pump 47 is connected to downstream section 452 by pump suction pipe L3. Atmospheric relief pipe L4 is connected to pump suction pipe L3. Atmospheric relief valve V3 is provided in atmospheric relief pipe L4. Atmospheric relief valve V3 need only be liked or connected to downstream section 452, and atmospheric relief pipe L4 can be attached to, for example, downstream section 452 or injection cylinder 32. Atmospheric relief valve V3 is connected to control unit 49. Vacuum pump 47 is in constant operation.

Detection device 48 detects the start and completion of the measurement process. Detection device 48 can be realized by, for example, an angle sensor that detects the angle of rotation of injection screw 33 and a position sensor that detects the position in the X-direction of injection screw 33. In the present disclosure, detection device 48 may be referred to as a “sensor.” Detection device 48 is connected to control unit 49. When the angle sensor detects the start of rotation of injection screw 33, control unit 49 determines that the measurement process of the molding material has started. When the position sensor detects that injection screw 33 has moved back in the −X-direction and reached a predetermined position in the X-direction, control unit 49 determines that the measurement process has been completed. The above predetermined position is determined in advance according to the amount of molding material used in one injection process and is stored in the control unit (not shown) of injection unit 3. Control unit 49 also determines that the measurement process has started when injection screw 33 starts to rotate in a case in which injection screw 33 starts to rotate and then retracts.

Detection device 48 outputs a start signal of the measurement process when the measurement process is started and a completion signal of the measurement process when the measurement process is completed. The start signal of the measurement process and the completion signal of the measurement process are sent to control unit 49. Upon receiving the start signal of the measurement process, control unit 49 opens cutoff device 46, and closes cutoff device 46 upon receiving the completion signal of the measurement process.

### Method for O perat ing and M ethod for V acuum D egassing Using Vacuum Degasser 4

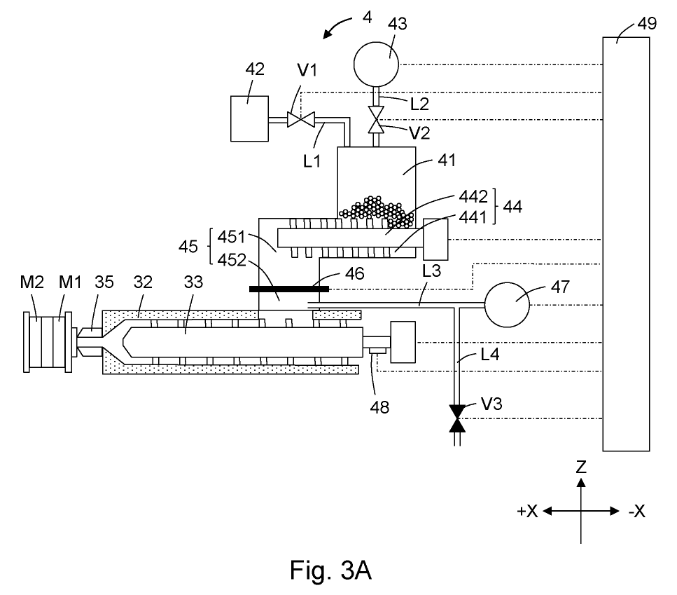

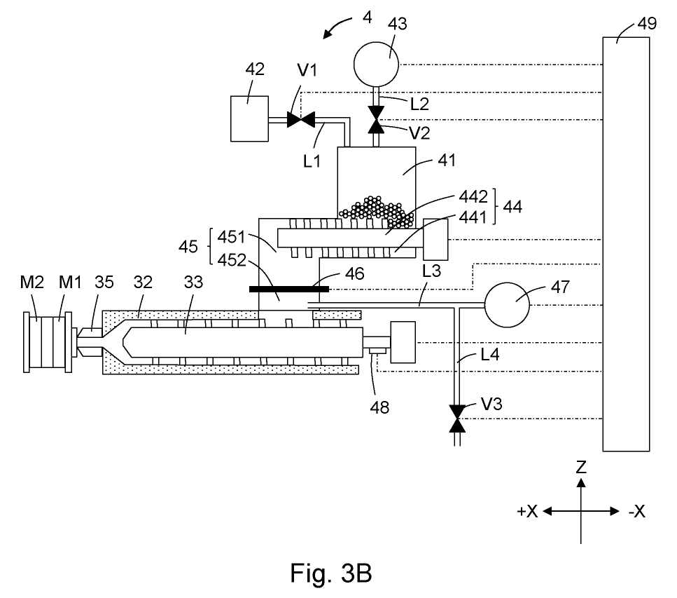

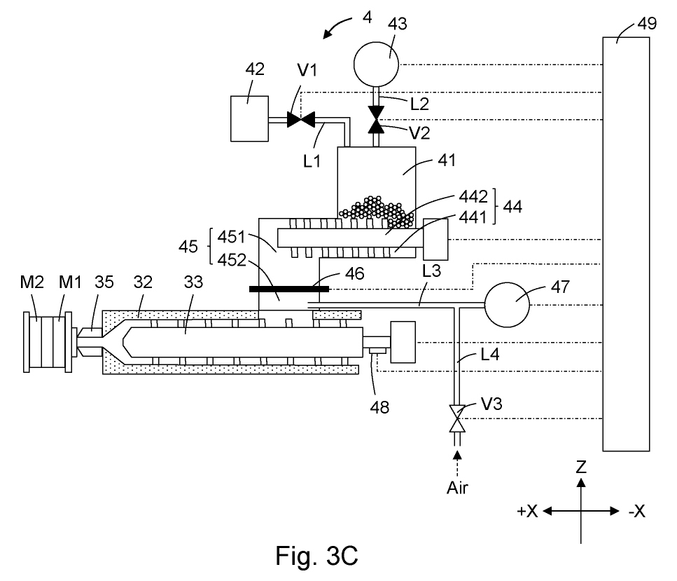

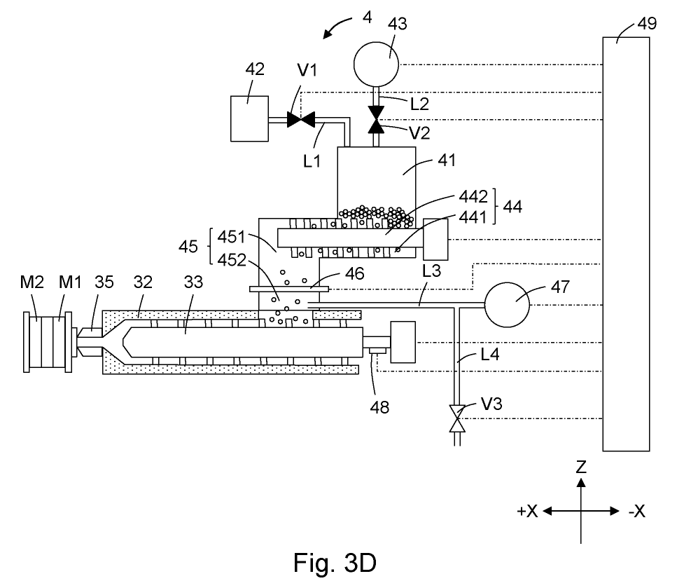

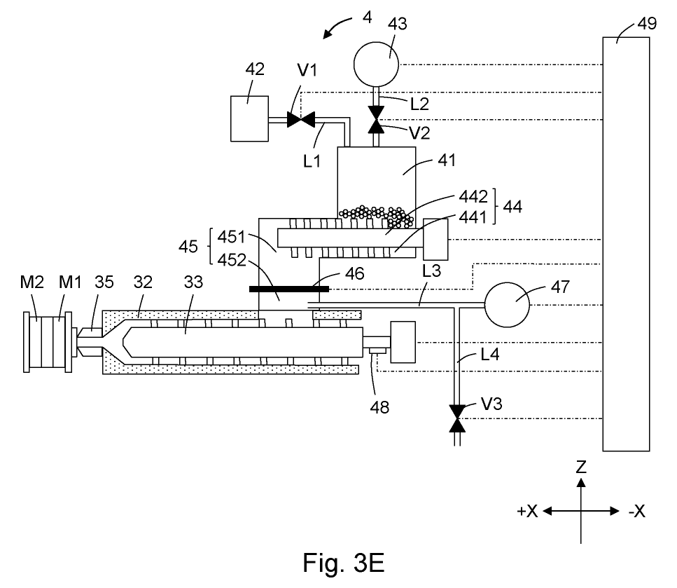

The method for operating and the method for vacuum degassing using vacuum degasser 4 shown in FIG. 2 are next described with reference to FIGS. 3A to 3E. First, as shown in FIG. 3A, control unit 49 opens feed control valve V1 and suction control valve V2 and activates evacuation blower 43. Evacuation blower 43 draws air from hopper 41, resulting in negative pressure inside hopper 41. Molding material stored in material tank 42 is fed into hopper 41 through material feed pipe L1. A filter (not shown) is disposed at the connection between hopper 41 and blower suction pipe L2 to prevent molding material from flowing into blower suction pipe L2. Because feed screw 442 is stopped, the molding material fed from material tank 42 remains above feed screw 442 in hopper 41.

Because cutoff device 46 and atmospheric relief valve V3 are closed, injection cylinder 32 and downstream section 452 are sealed space. Regardless of whether the injection process of the previous cycle has been completed, water and volatile components will have accumulated inside injection cylinder 32. The water and volatile components that remain in injection cylinder 32 and downstream section 452 are removed by vacuum pump 47. In particular, when the injection process of the previous cycle has not been completed, as describe below, water and volatile components may be generated from the molding material that is heated and melted, and water and volatile components thus produced are also removed by vacuum pump 47.

Next, as shown in FIG. 3B, control unit 49 closes feed control valve V1 and suction control valve V2. Upstream section 451 of material supply path 45 and hopper 41 become a sealed space. Since injection cylinder 32 and downstream section 452 continue to be a sealed space, vacuum pump 47 continues to remove water and volatile components that are retained in injection cylinder 32 and downstream section 452.

Next, as shown in FIG. 3C, control unit 49 opens atmospheric relief valve V3. Atmospheric relief valve V3 is opened in a state that precedes the measurement process and that cutoff device 46 and atmospheric relief valve V3 are closed and vacuum pump 47 is in operation. The pressure in injection cylinder 32 and downstream section 452 increases but remains below air pressure because vacuum pump 47 is operating.

Next, as shown in FIG. 3D, control unit 49 starts the measurement process by activating injection screw 33. Control unit 49 receives a measurement process start signal from detection device 48. Upon receiving this signal, control unit 49 opens cutoff device 46 and activates feed screw 442. Vacuum pump 47 is caused to operate even while cutoff device 46 is open. The molding material that remains in hopper 41 is conveyed by feed screw 442, falls down material supply path 45, and is fed to injection cylinder 32. Injection screw 33 retracts in the −X-direction while rotating and conveys the molten molding material to the front (the +X-direction side) of injection screw 33. Atmospheric relief valve V3 remains open during the measurement process. While cutoff device 46 is open, injection cylinder 32, material supply path 45, conveyance equipment 44, and hopper 41 form a single space.

Upon receiving a signal from detection device 48 that the measurement process has been completed, control unit 49 closes cutoff device 46 and atmospheric relief valve V3 and stops feed screw 442 as shown in FIG. 3E. The supply of molding material from material supply path 45 to injection cylinder 32 stops. Although not shown in the drawings, injection screw 33 then moves forward in the +X-direction to execute the injection process of injecting the molten molding material. The state then returns to the condition shown in FIG. 3A, and the processes shown in FIGS. 3A to 3E are repeated.

### Effect s of th e Present Embodiment

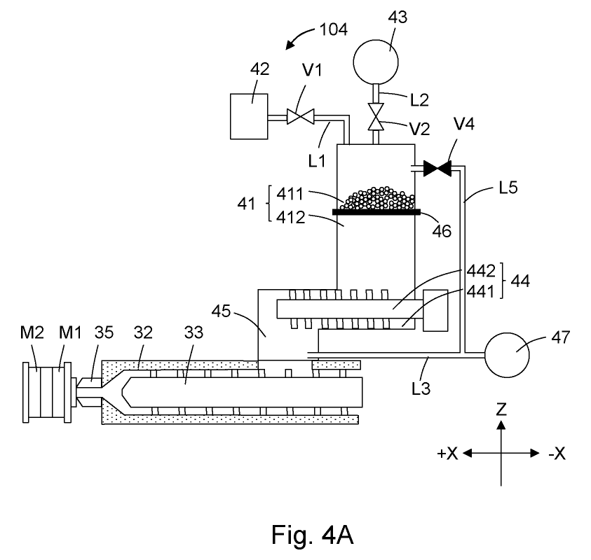

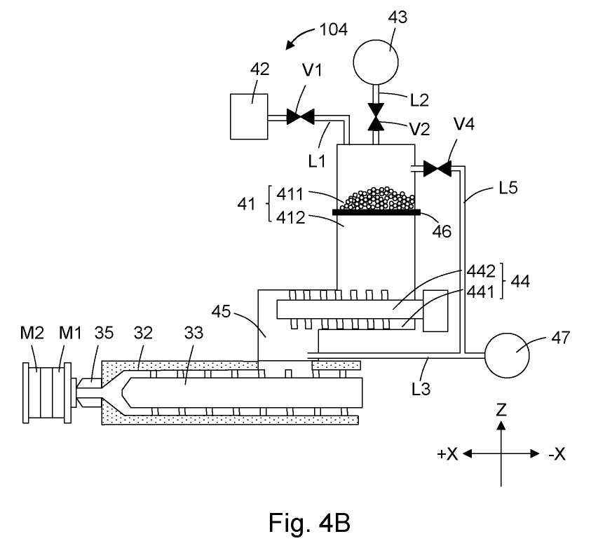

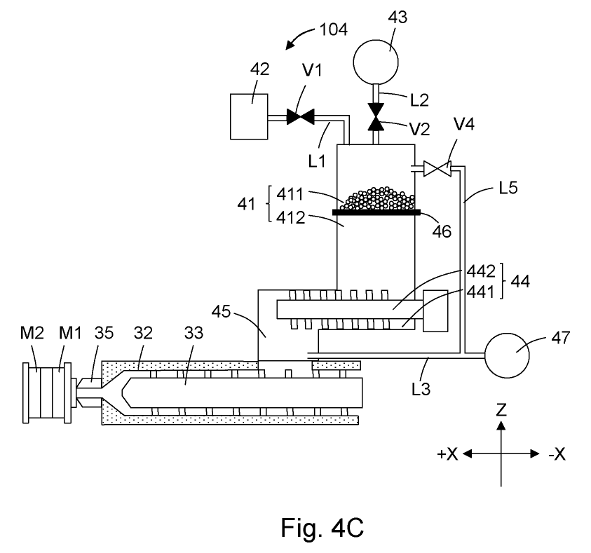

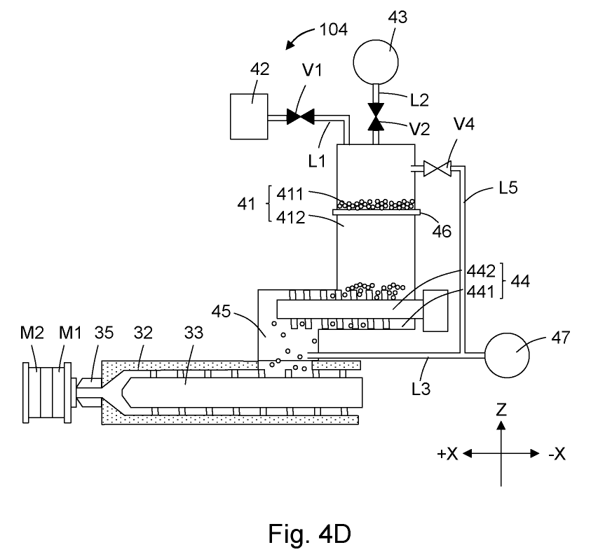

The effects of the present embodiment are next described by comparison with a comparative example. FIGS. 4A to 4D are similar to FIGS. 3A to 3E and show the operation of vacuum degasser 104 in the comparative example. The control unit is not shown in the drawings. In the comparative example, cutoff device 46 is located in hopper 41, and cutoff device 46 divides hopper 41 into upstream section 411 and downstream section 412. Hopper suction pipe L5 is connected to upstream section 411 of hopper 41 and is then joined with pump suction pipe L3. Hopper suction pipe L5 is provided with valve V4. Vacuum pump 47 is in constant operation.

First, as shown in FIG. 4A, feed control valve V1 and suction control valve V2 are opened and evacuation blower 43 is activated. The molding material stored in material tank 42 is fed into hopper 41 through material feed pipe L1. Cutoff device 46 is closed, and the molding material fed from material tank 42 therefore stays in upstream section 411 of hopper 41 (above cutoff device 46).

Next, as shown in FIG. 4B, feed control valve V1 and suction control valve V2 are closed to thereby seal upstream section 411 of hopper 41. Then, as shown in FIG. 4C, valve V4 of hopper suction pipe L5 is opened to evacuate upstream section 411 of hopper 41. Upstream section 411 and downstream section 412 of hopper 41, material supply path 45, and injection cylinder 32 are simultaneously evacuated by vacuum pump 47 and are therefore at the same pressure.

As shown in FIG. 4D, when the measurement process is started, cutoff device 46 is opened and feed screw 442 is activated. The molding material that was left above cutoff device 46 is conveyed by feed screw 442 and fed through material supply path 45 to injection cylinder 32. When the measurement process is completed, cutoff device 46 is closed. These processes shown in FIGS. 4A to 4D are then repeated.

In the comparative example, cutoff device 46 is closed and vacuum pump 47 is operating in the processes shown in FIGS. 4A and 4B, and as a result, injection cylinder 32, material supply path 45, and downstream section 412 of hopper 41 are maintained at approximately constant pressure. In the process shown in FIG. 4C, injection cylinder 32, material supply path 45, and downstream section 412 of hopper 41 are maintained at approximately the same pressure as in the processes shown in FIGS. 4A and 4B, and upstream section 411 of hopper 41 is depressurized until the pressure is the same as in downstream section 412. The process shown in FIG. 4D is executed with upstream section 411 and downstream section 412 of hopper 41 at equalized pressure.

Therefore, in the processes shown in FIGS. 4A to 4D, injection cylinder 32, material supply path 45, and downstream section 412 of hopper 41 are maintained at almost constant pressure, and airflow is unlikely to occur in these spaces. In addition, although vacuum pump 47 is operating, injection cylinder 32, material supply path 45, and downstream section 412 of hopper 41 are always in a high-vacuum state, and as a result, the amount of evacuation per unit time is small. For these reasons, water and volatile components that have accumulated in injection cylinder 32, material supply path 45, and downstream section 412 of hopper 41 are difficult to remove efficiently.

In the present embodiment, atmospheric relief valve V3 is opened in the process shown in FIG. 3C, whereby some of the air flowing from atmospheric relief valve V3 flows into injection cylinder 32 and downstream section 452 of material supply path 45. This airflow disturbs the air in injection cylinder 32 and downstream section 452 of downstream section 452 of material supply path 45 and thus facilitates the flow of water and volatile components that have remained stagnant in the injection cylinder 32 and the downstream portion 452 of material supply path 45, and the water and volatile components are thus efficiently discharged by vacuum pump 47.

Opening cutoff device 46 in the process shown in FIG. 3D connects upstream section 451 and downstream section 452 of material supply path 45 and facilitates the generation of airflow in upstream section 451 as well. In other words, airflow is generated from upstream section 451 and downstream section 452 of material supply path 45, hopper 41, and injection cylinder 32 to vacuum pump 47. Although upstream section 451 of material supply path 45 has already been evacuated by evacuation blower 43, the pressure does not drop significantly and is almost the same level as atmospheric pressure. Therefore, the pressure difference between upstream section 451 and downstream section 452 of material supply path 45 further facilitates the generation of airflow.

In other words, because injection cylinder 32 and downstream section 452 of material supply path 45 repeatedly change between a low-pressure state (FIGS. 3A, 3B, and 3E) and a high-pressure state (FIGS. 3C and 3D) during one injection cycle, the pressure difference generates airflow in injection cylinder 32 and downstream section 452 of material supply path 45. The water and volatile components that have accumulated in these spaces are agitated by this airflow and are efficiently discharged by vacuum pump 47. Furthermore, in the process shown in FIG. 3D, upstream section 451 of material supply path 45 in which pressure is at the same level as atmospheric pressure is connected to downstream section 452 and injection cylinder 32 with the result that both the amount of evacuation by vacuum pump 47 and the airflow speed are greater than in the comparative example. These effects bring about more efficient removal of water and volatile components.

Atmospheric relief valve V3 can be opened after the measurement process has started but is preferably opened before the measurement process starts. Water and volatile components may adhere to the surface of the molding material or may remain inside the molding material and thus discharged by heating and melting. In the present embodiment, after airflow is generated in injection cylinder 32 and downstream section 452 of material supply path 45 by the process shown in FIG. 3C, the molding material is fed into material supply path 45 by the process shown in FIG. 3D. In other words, when the molding material is fed into material supply path 45, airflow is already generated in injection cylinder 32 and downstream section 452 of material supply path 45, whereby water and volatile components adhering to the surface of the molding material can be removed quickly after the molding material is fed into material supply path 45.

The present embodiment enables more efficient removal of water and volatile components from molding materials than in the comparative example as described above but also provides several additional advantages. First, the present embodiment also eliminates the need for hopper suction pipe L5 and valve V4 of the comparative example. In addition, while hopper 41 in the comparative example must be substantially airtight because the pressure drops to the same degree of vacuum as in injection cylinder 32 (see FIG. 4C), but hopper 41 in the present embodiment does not need to be exceptionally airtight because evacuation blower 43 causes only a slightly negative internal pressure.

Furthermore, while the comparative example requires the use of hopper 41 that is connected to hopper suction pipe L5, no particular limitations apply to the form of hopper 41 in the present embodiment. In the present embodiment employs a sealed hopper 41 and material tank 42 that are connected to material feed pipe L1 and blower suction pipe L2, but can also use a less costly hopper with an open top, and further, can omit material tank 42. In this case, in place of the processes shown in FIGS. 3A to 3C, an operator can manually feed molding material into hopper 41.

While preferred embodiments of the invention have been shown and described in detail, it is to be understood that various changes and modifications can be made without departing from the intent or scope of the appended claims.

### LIST OF REFERENCE NUMERALS

3 injection unit

4 vacuum degasser

32 injection cylinder

33 injection screw

41 hopper

44 conveyance equipment

45 material supply path

46 cutoff device

47 vacuum pump

48 detection device (sensor)

49 control unit

451 upstream section

452 downstream section

L3 pump suction pipe

L4 atmospheric relief pipe

V3 atmospheric relief valve

1. A vacuum degasser, comprising:
conveyance equipment that conveys a molding material into an injection cylinder;
a material supply path that is provided between said injection cylinder and said conveyance equipment and that supplies said molding material to said injection cylinder;
a cutoff device that divides said material supply path into an upstream section that is connected to said conveyance equipment and a downstream section that is connected to said injection cylinder;
a vacuum pump that is connected to said downstream section; and
an atmospheric relief valve that is connected to said downstream section, wherein
said atmospheric relief valve is opened in a state that precedes a measurement process and that said cutoff device and said atmospheric relief valve are closed and said vacuum pump is in operation.

2. The vacuum degasser according to claim 1, further comprising:
a pump suction pipe that connects said downstream section to said vacuum pump; and
an atmospheric relief pipe that is connected to said pump suction pipe, wherein
said atmospheric relief valve is provided in said atmospheric relief pipe.

3. The vacuum degasser according to claim 1, wherein
said atmospheric relief valve is opened during said measurement process.

4. The vacuum degasser according to claim 3, wherein
said atmospheric relief valve is closed after said measurement process is completed.

5. The vacuum degasser according to claim 1, wherein
said cutoff device is opened during said measurement process, and said vacuum pump is operated while said cutoff device is opened.

6. The vacuum degasser according to claim 1, further comprising:
a sensor that detects a start and completion of said measurement process, wherein
said cutoff device is opened after said sensor detects the start of said measurement process and is closed after said sensor detects the completion of said measurement process.

7. An injection unit, comprising:
an injection cylinder; and
a vacuum degasser that is attached to said injection cylinder,
wherein said vacuum degasser comprises:
conveyance equipment that conveys a molding material into said injection cylinder;
a material supply path that is provided between said injection cylinder and said conveyance equipment and that supplies said molding material to said injection cylinder;
a cutoff device that divides said material supply path into an upstream section that is connected to said conveyance equipment and a downstream section that is connected to said injection cylinder;
a vacuum pump that is connected to said downstream section; and
an atmospheric relief valve that is connected to said downstream section, wherein
said atmospheric relief valve is opened in a state that precedes a measurement process and that said cutoff device and said atmospheric relief valve are closed and said vacuum pump is in operation.

8. The injection unit according to claim 7, further comprising:
a pump suction pipe that connects said downstream section to said vacuum pump; and
an atmospheric relief pipe that is connected to said pump suction pipe, wherein
said atmospheric relief valve is provided in said atmospheric relief pipe.

9. The injection unit according to claim 7, wherein
said atmospheric relief valve is opened during said measurement process.

10. The injection unit according to claim 9, wherein
said atmospheric relief valve is closed after said measurement process is completed.

11. The injection unit according to claim 7, wherein
said cutoff device is opened during said measurement process and said vacuum pump is operated while said cutoff device is opened.

12. The injection unit according to claim 7, further comprising:
a sensor that detects a start and completion of said measurement process,
wherein
said cutoff device is opened after said sensor detects the start of said measurement process and is closed after said sensor detects the completion of said measurement process.

13. A method for vacuum degassing using a vacuum degasser that comprises:
conveyance equipment that conveys a molding material into an injection cylinder;
a material supply path that is provided between said injection cylinder and said conveyance equipment and that supplies said molding material to said injection cylinder;
a cutoff device that divides said material supply path into an upstream section that is connected to said conveyance equipment and a downstream section that is connected to said injection cylinder;
a vacuum pump that is connected to said downstream section; and
an atmospheric relief valve that is connected to said downstream section, the method comprising a step of:
opening said atmospheric relief valve in a state that precedes a measurement process and that said cutoff device and said atmospheric relief valve are closed and said vacuum pump is in operation.

14. The method for vacuum degassing according to claim 13, wherein said vacuum degasser further comprises:
a pump suction pipe that connects said downstream section to said vacuum pump; and
an atmospheric relief pipe that is connected to said pump suction pipe, wherein
said atmospheric relief valve is provided in said atmospheric relief pipe.

15. The method for vacuum degassing according to claim 13, wherein
said atmospheric relief valve is opened during said measurement process.

16. The method for vacuum degassing according to claim 15, wherein
said atmospheric relief valve is closed after said measurement process is completed.

17. The method for vacuum degassing according to claim 13, wherein
said cutoff device is opened during said measurement process and said vacuum pump is operated while said cutoff device is opened.

18. The method for vacuum degassing according to claim 13, wherein said vacuum degasser further comprises:
a sensor that detects a start and completion of said measurement process,
wherein
said cutoff device is opened after said sensor detects the start of said measurement process and is closed after said sensor detects the completion of said measurement process.
